(19) United States
(12) Patent Application Publication
(10) Pub. No.: US 2022/0187497 A1
(43) Pub. Date: Jun. 16, 2022

(54) A METHOD FOR FORMING COARSE-SCALE 3D MODEL OF HETEROGENEOUS SEDIMENTARY STRUCTURES

(71) Applicant: TOTALENERGIES SE, Courbevoie (FR)

(72) Inventors: Gérard MASSONNAT, Pau (FR); David LEDEZ, Pau (FR)

(21) Appl. No.: 17/603,288

(22) PCT Filed: Apr. 16, 2019
(86) PCT No.: PCT/IB2019/000522

§ 371 Date: Oct. 12, 2021

(51) Int. Cl. G01V 99/00

(52) U.S. Cl. CPC G01V 99/005

(57) ABSTRACT

The invention discloses a method for forming a coarse-scale three-dimensional geological model of sedimentary structures, the method being implemented by a computer, and comprising: —forming a fine-scale three dimensional model of the sedimentary structures, by implementing steps of: o modeling a plurality of meshed sedimentary surfaces, the plurality of meshed sedimentary surfaces delimiting superposed layers of lithology, o forming an unstructured grid comprising a plurality of cells, wherein each cell extends between at least two sedimentary surfaces, o attributing petrophysical parameters to each cell of the grid, and o attributing, to at least some of the sedimentary surfaces, a transmissivity reduction coefficient, and —upscaling the fine-scale three dimensional model to obtain a coarse-scale three dimensional model comprising a plurality of cells, wherein each cell is associated to petrophysical parameters determined from the petrophysical parameters of the fine-scale model, and from the transmissivity reduction coefficient of the sedimentary surfaces.

### FIELD OF THE INVENTION

The invention relates to a method, a program and a computer readable medium storing such a program for forming a coarse-scale geological model of sedimentary structures.

### TECHNICAL BACKGROUND

Subsurface reservoirs are highly heterogeneous and complex formations, which need to be characterized precisely in order to allow proper estimation of the exploitable reserves, and provide information for appropriate localization of production wells.

In order to characterize reservoirs, it is known to create high-resolution geological models, which are often composed of millions of grid cells, each grid cell being assigned geological properties, for instance being assigned a rock type (sandstone, siltstone, shale), as well as petrophysical properties such as porosity and permeability.

The filling of these fine-scale models is based upon experimental data, acquired for example from on-site core drilling operations or logging.

Once this fine-scale model is obtained, it is usually not possible to directly perform computations thereon or numerical simulations, in acceptable delays, as the number of grid cells is extremely important (10⁷-10⁸ grid cells per model, each cell having dimensions of a few meters).

Therefore it is also known to perform upscaling of this fine-scale geological model to obtain a coarse-scale geological model, having less grid cells (10⁴-10⁶ per model, each cell having dimensions of tens of meters), wherein the grid cells represent bigger volumes than the grid cells of the fine-scale model. Upscaling techniques comprise the computation of petrophysical properties of the coarse-scale model from the properties of the cells of the fine-scale model.

Upscaling of porosity can be performed quite simply, since an equivalent porosity value of a coarse-scale cell is an average of the porosity values of the fine-scale cells included in the coarse-scale cell.

However, computing equivalent permeability values is more complex as it usually implies solving a flow problem over a region included in the coarse-scale cell. In this context, it is sometimes very complex to take into account local heterogeneities of permeability, such as thin shale layers, which however impact the permeability of the whole region.

In a previous approach of reservoir modelling, both the fine-scale model and the coarse-scale model comprised grid cells of cubic shape and constant dimensions. This approach however cannot faithfully represent sedimentary structures in which the boundaries between different rock types are not necessarily horizontal or vertical.

It has then been proposed by David M. Rubin et al., in Cross-Bedding, Bedforms, and Paleocurrents, ISBN (electronic): 9781565761018, SEPM Society for Sedimentary Geology, 1987 a reservoir modelling technique in which sedimentary layers are modelled as parametric surfaces, each surface corresponding to a boundary between two sedimentary layers of identical or different lithology.

This work allowed a better representation of complex geological structures, but it still has some drawbacks. In particular, representation of very thin layers, such as thin layers of shale evoked above, is not possible apart from adding parametric surfaces representing the boundaries of these layers. However, as these layers can have a thickness of a few millimeters only, taking into account this kind of layer can greatly increase the number of surfaces and hence of grid cells, which in turn makes it more complex to run simulations or computations on the model.

### PRESENTATION OF THE INVENTION

In view of the above, there is a need for a simplified, yet more precise modelling method of sedimentary structures.

Accordingly, the present invention aims at providing an improved method for modelling sedimentary structures. In particular, the present invention aims at providing a modelling method which can take into account local heterogeneities in the sedimentary structures, especially local heterogeneities in the permeability values of the sedimentary structures.

To this end, the invention proposes a method for forming a coarse-scale three-dimensional geological model of sedimentary structures, the method being implemented by a computer, and comprising:
forming a fine-scale three dimensional model of the sedimentary structures, by implementing steps of:
   modeling a plurality of meshed sedimentary surfaces, the plurality of meshed sedimentary surfaces delimiting superposed layers of lithology,
   forming an unstructured grid comprising a plurality of cells, wherein each cell extends between at least two sedimentary surfaces,
   attributing petrophysical parameters to each cell of the grid, and
   attributing, to at least some of the sedimentary surfaces, a transmissivity reduction coefficient, and
upscaling the fine-scale three dimensional model to obtain a coarse-scale three dimensional model comprising a plurality of cells, wherein each cell is associated to petrophysical parameters determined from the petrophysical parameters of the fine-scale model, and from the transmissivity reduction coefficient of the sedimentary surfaces.

In embodiments, the sedimentary surfaces are meshed with triangles, and the step of forming the unstructured grid comprises forming a plurality of tetraedric cells between two successive sedimentary surfaces, such that one face of a tetraedric cell corresponds to a triangular mesh of a sedimentary surface, and the summit of the tetraedric cell belongs to an adjacent sedimentary surface.

The transmissivity reduction coefficient is preferably comprised between 0 and 1, and a modeled sedimentary surface having a transmissivity reduction coefficient of 0 may represent a thin shale layer.

In embodiments, the step of attributing petrophysical parameters to each cell of the grid of the fine-scale model comprises:
determining a number of lithology types within the fine-scaled model and defining each lithology type,
determining a distribution pattern of the lithology types within the grid, and
attributing to each cell petrophysical parameters according to the determined distribution pattern.

The petrophysical parameters preferably comprise at least porosity and permeability values.

In embodiments, the upscaling is performed by providing a coarse-scale grid comprising a plurality of cells, each cell having dimensions greater than a plurality of cells of the fine-scale model, and the upscaling of the permeability values is performed by computing equivalent fluid flow values of the cells of the coarse-scale grid from fluid flow values of the cells of the fine-scale grid and inferring equivalent permeability values of the coarse-scale grid.

In an embodiment, the computation of the equivalent permeability values is performed by:
numerically solving—Darcy's equation to obtain, in each cell of the fine-scale model, a fluid head in the cell, said fluid head being determined from fluid head values at the limits of the fine-scale model, inferring a fluid flow value in each cell of the fine-scale model,
computing, from the fluid flow values in each cell and the transmissivity reduction coefficients, an equivalent fluid flow value in a cell of the coarse-scale grid comprising the cells of the fine-scale grid, and
inferring an equivalent permeability value of the cell of the coarse-scale grid from the equivalent fluid flow value.

In embodiments, the modelling of sedimentary surfaces comprises:
selecting a bedform type to be modelled among a library of previously established bedform types, wherein each bedform type defines a disposition of a plurality of sedimentary surfaces, and
parameterizing the selected bedform type.

The parameterizing of the bedform type may be performed according to at least one of the following parameters:
wavelength of a cyclic geometric pattern of the sedimentary surfaces included in the bedform type,
Steepness of said cyclic geometric pattern,
Angular orientation of said cyclic geometric pattern,
Number of sedimentary surfaces, and
Mean thickness between two adjacent sedimentary surfaces.

According to another object, a computer program product is disclosed, comprising code instructions for performing the method according to the description above, when executed by a computer.

According to another object; a non-transitory computer readable storage medium is disclosed, having stored thereon a computer program comprising program instructions, the computer program being loadable into a computer and adapted to cause the computer to carry out the steps of the method described above, when the computer program is run by the computer.

The present invention proposes a method for modelling complex geological structures, by forming a fine-scale model of the structures in which surfaces are used as boundaries between layers of rocks, but also to represent thin layers of shale which can reduce the global permeability of the structure. To this end, surfaces are attributed a transmissivity reduction coefficient. The transmissivity reduction coefficient is comprised between 0 and 1 and, when equal to 1, allows representing thin shale layers with only a parametric surface.

Upscaling can then be performed based on transmissivity values of the fine scale grid cells, and the local heterogeneities in transmissivity or permeability are taken into account in a coarse-scale model.

### DESCRIPTION OF THE DRAWINGS

Other features and advantages of the invention will be apparent from the following detailed description given by way of non-limiting example, with reference to the accompanying drawings, in which:

FIG. 1 schematically represents the main step of a method for forming a coarse-scale three dimensional geological model of sedimentary structures according to an embodiment of the invention.

FIGS. 2a to 2f show exemplary sedimentary surfaces delimiting layers of lithology,

FIG. 3a schematically shows an exemplary fine grid, and FIG. 3b schematically shows a corresponding coarse-scale grid obtained from the fine grid of FIG. 3a

FIG. 4 schematically shows a computer for implementation of the method.

### DETAILED DESCRIPTION OF AT LEAST AN EMBODIMENT OF THE INVENTION

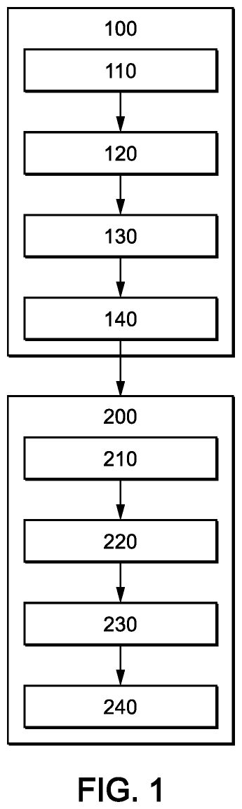

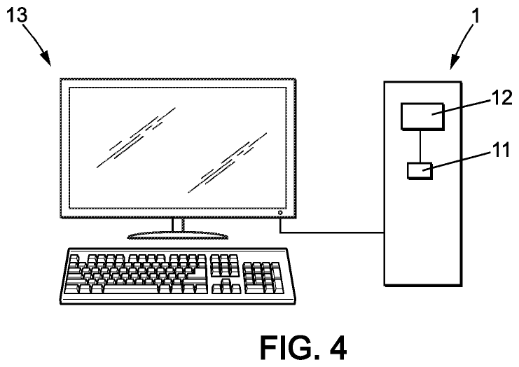

With reference to FIG. 1, the main steps of a method for forming a coarse-scale three-dimensional geological model of sedimentary structures will now be described. As shown in FIG. 4, this method is implemented by a system 1, comprising a computer 11 which can be for instance a processor, microprocessor, controller, etc., executing code instructions stored in a memory 12. Preferably, this method is implemented as a software application having an interface which can be displayed on a screen 13, allowing a user to select parameters for personalizing the three-dimensional model to be built.

This method allows forming a coarse-scale model comprising a grid having a plurality of cells, in which each cell is assigned petrophysical parameters which faithfully take into account local values of petrophysical parameters, including local heterogeneities in permeability values of the sedimentary structure.

A first step 100 of the method is the formation of a fine-scale three-dimensional model of the sedimentary structures, the model comprising a grid having a plurality of cells, wherein each cell is assigned petrophysical parameters.

Step 100 comprises a first substep 110 of modeling a plurality of sedimentary surfaces, representing the boundaries between superposed layers of lithology. The disposition of a stack of sedimentary surfaces is also called bedform. For some very thin layers of lithology, and as will be disclosed in more details below, a modeled surface may represent the whole layer itself. This applies for layers having a thickness of a few centimeters maximum.

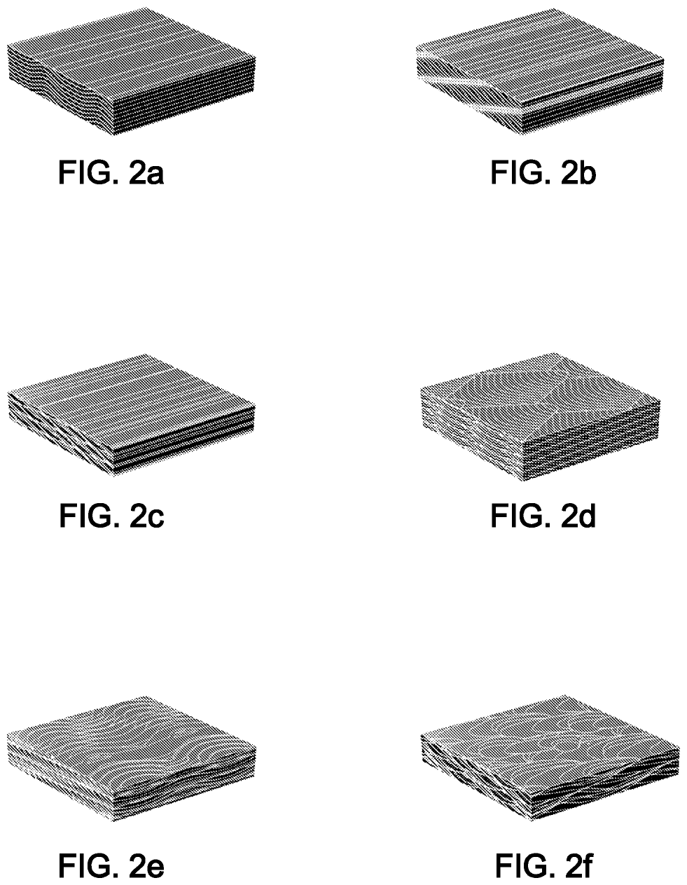

The modeling of the surfaces is preferably performed according to the method disclosed by David M. Rubin et al., in Cross-Bedding, Bedforms, and Paleocurrents, ISBN (electronic): 9781565761018, SEPM Society for Sedimentary Geology, 1987, cited above. This method allows modeling a plurality of bedform types, such as the number of examples illustrated in FIGS. 2a to 2f, where each bedform type defines a disposition of a plurality of sedimentary surfaces. Preferably, a library of bedform types is stored in the memory and can be chosen by the user.

Then, once a bedform type is chosen, a number of parameters may be used to model each bedform type as required, such that, for instance, a wavelength of a cyclic geometric pattern of the sedimentary surfaces included in the bedform type, a maximum steepness of said cyclic geometric pattern, an angular orientation, relative to the North, of said cyclic geometric pattern. The model is also parameterized with a number of surfaces to be formed in the model and a mean thickness between two adjacent surfaces. The total thickness of the bedform may also be parameterized, and hence the number and mean thickness of the sedimentary surfaces are constrained by this total thickness.

The surfaces are further meshed with a triangular pattern, to form a plurality of two-dimensional triangular meshes. The size of the triangular meshes can be set by the user.

Step 100 then comprises a substep 120 of forming an unstructured grid comprising a plurality of three dimensional cells, wherein each cell extends between two successive sedimentary surfaces. The unstructured grid is obtained by first forming a plurality of tetraedric cells between the sedimentary surfaces, such that at least one face of a cell belongs to one sedimentary surface. Preferably, each cell extends between two sedimentary surfaces, having one face corresponding to one of the triangular meshes of a sedimentary surface, and the summit belonging to an adjacent sedimentary surface.

Optionally, step 120 then comprises recombining the formed tetraedric cells to obtain hexaedric cells extending between two adjacent sedimentary surfaces. Cell recombination is well known to the skilled person and can for instance be implemented according to the method disclosed in Arnaud Botella: “Génération de maillages non structures volumiques de modèles géologiques pour la simulation de phénomènes physiques, Géophysique [physics.geo-ph]. Université de Lorraine, 2016. <NNT: 2016LORR0097>.

At the end of this step a fine-scale grid is thus obtained, in which each cell is defined between two adjacent sedimentary surfaces.

Step 100 of forming the fine-scale model then comprises a substep 130 of attributing petrophysical parameters to each three-dimensional cell of the grid. To this end, the user may determine a number of lithologies constituting the model of sedimentary structure, and define each lithology, so as to attribute a lithology to the cells belonging to each layer extending between two adjacent sedimentary surfaces.

For instance, the user may select one or two lithologies, such as:
Sandstone,
Siltstone,
Shale, etc.

According to the number of lithologies, the user may further define a distribution pattern of the various lithologies among the model. The distribution pattern is applied to the layers between adjacent sedimentary surfaces. Examples of distribution patterns for two lithologies are as follows:
Alternating layers, with a first number of layer(s) of the first lithology alternating with a second number of layer(s) of the second lithology,
Cyclic pattern, comprising a distribution of alternating layers of the two lithologies, repeating itself,
Progressive preponderance pattern, comprising a distribution of alternating layers of the two lithologies progressively moving towards one lithology being preponderant over the other, etc.

According to this pattern, each cell belonging to a layer between successive sedimentary surface is then attributed a lithology and hence petrophysical parameters defined by the lithology. The petrophysical parameters comprise at least values of porosity, permeability.

Last, during step 140, each sedimentary surface is also assigned a parameter which is a transmissivity reduction coefficient, comprised between 0 and 1. A coefficient equal to 1 implies no reduction on the transmissivity between the cells located on both sides on the sedimentary surface. On the other hand, a transmissivity reduction coefficient equal to 0 corresponds to an impervious layer, and is advantageously used to model thin shale layers, which can be fully impervious despite a reduced thickness. The value of the transmissivity reduction coefficient is assigned to each sedimentary surface by a user according to its knowledge of the sedimentary structure to be modelled. According to a preferred embodiment, the value of each transmissivity reduction coefficient is set by default at 1 and can be selectively changed by the user.

Substep 140 may be performed at any time after substep 110, and not exclusively after step 130.

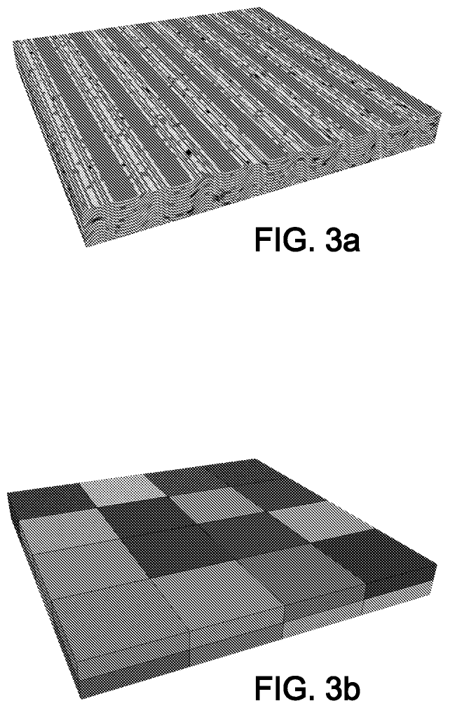

With reference to FIG. 3a, an example of a fine-scale three-dimensional model obtained at the end of step 100 is shown.

The method then comprises a step 200 of upscaling this fine-scale model to obtain a coarse-scale three dimensional model, an example of which is shown in FIG. 3b. The coarse-scale three dimensional model comprises a coarse-scale three dimensional grid which cells are preferentially parallelepipeds

The dimensions of the cells of the three-dimensional grid are preliminary selected by a user, either at the beginning of step 200 or even before step 100. The dimensions of the cells of the coarse-scale grid are greater than those of the fine-scale grids. According to an example, a cell of the coarse-scale grid may have lateral dimensions of several tens of meters, up to hundreds of meters, and a height of at least several meters, up to tens or hundreds of meters, whereas the dimensions of a cell of a fine-scale grid are about between some tens of centimeters and some meters.

The upscaling 200 then comprises the determination of equivalent petrophysical parameters assigned to each cell of the coarse-scale model, the equivalent petrophysical parameters being determined based on the parameters assigned to the cells of the fine-scale model, and the transmissivity reduction coefficients of the sedimentary surfaces, in order to take into account local heterogeneities in transmissivity or permeability.

The equivalent petrophysical parameters assigned to a cell of the coarse-scale model comprise at least an equivalent porosity value, and an equivalent permeability value. Regarding the equivalent porosity value, it is computed as a mean value, over the cells of the fine-scale model comprised in the cell of the coarse-scale model. Regarding the equivalent permeability value, it is solved by numerically solving Darcy's equation describing the flow of a fluid through a porous medium, applied on unstructured grids, and which reads as follows:

div(\vec{q})=0 within Ω

with \vec{q}=−K∇h

Where Ω is the computation domain, \vec{q} is a three-dimensional method of the flow of fluid within the domain, K is the permeability value of the domain, and h is a head gradient vector.

This equation is discretized on the boundaries conditions of the fine-scale grid thanks to a mixed hybrid finite elements method, in order to obtain a sparse linear matrix system:

$$[ \begin{matrix}{a}_{11} & ⋯ & {a}_{1 n} \\ ⋮ & ⋱ & ⋮ \\ {a}_{n 1} & ⋯ & {a}_{nn}\end{matrix} ] \times [ \begin{matrix}{h}_{1} \\ … \\ {h}_{n}\end{matrix} ] = [ \begin{matrix}{h}_{li m 1} \\ … \\ {h}_{limn}\end{matrix} ]$$

In this system, n is the number of cells in the fine-scale grid, aᵢⱼ represents the permeability values of the cells of the fine-scale grid and the links between the permeability values of adjacent cells of the grid, h_{1 . . . n} represents the head in each cell of the fine-scale grid, and h_{lim1 . . . n} represents imposed conditions at the limits of the grid, therefore most values of hₗᵢₘᵢ are equal to 0 except on the limits of the grid.

This matrix system is solved during a substep 210 using a multigrid solving algorithm to obtain a value of head hᵢ in each cell of the fine-scale grid, which in turns allows computing during substep 220 a value of fluid flow \vec{q} through the cell, thanks to the above equation.

The fluid flow Q through a face, of surface S, of a cell of the coarse-scale grid, the face being orthogonal to the direction of the flow, is then computed during substep 230 by:

$$Q = {\sum }_{s} \vec{{q}_{s}} ( MultS ) \cdot S$$

Where s designates all the sedimentary surfaces comprised within the cell of the coarse-scale grid, and Mults is the transmissivity reduction coefficient associated to a sedimentary surface S.

The equivalent permeability of a cell of the coarse-scale grid is then computed during substep 240 by:

$${K}_{e q} = \frac{Q}{S ∇ h}$$

This computation is performed along the three directions of the coarse-scale grid to obtain all the values of the permeability tensor.

Two types of boundaries conditions may be used for computing the equivalent permeability.

According to a first embodiment, a constant pressure difference is imposed between the two opposite faces of the cell of the coarse-scale grid orthogonal the fluid flow direction, assuming that the other faces, parallel to the fluid flow direction, are watertight. In this configuration, only the computation of the diagonal terms of the permeability tensor is possible.

According to a second embodiment, a constant pressure difference is imposed between the two opposite faces of the cell of the coarse-scale grid orthogonal the fluid flow direction, imposing a linear pressure difference on all the faces which are parallel to the fluid flow direction. This configuration leads to computing all the terms, including the crossed terms, of the permeability tensor.

Thus it is apparent that parameterizing the sedimentary surfaces with a transmissivity reduction coefficient, and taking into account this coefficient in the computation of an equivalent permeability value, allows taking into account local heterogeneities of permeability. It can even allow taking into account thin watertight layers which otherwise would not be modeled as they would imply too much computational needs.

1. A method for forming a coarse-scale three-dimensional geological model of sedimentary structures, the method being implemented by a computer, and comprising:
forming a fine-scale three dimensional model of the sedimentary structures, by implementing steps of:
modeling a plurality of meshed sedimentary surfaces, the plurality of meshed sedimentary surfaces delimiting superposed layers of lithology,
forming an unstructured grid comprising a plurality of cells, wherein each cell extends between at least two sedimentary surfaces,
attributing petrophysical parameters to each cell of the grid, and
attributing, to at least some of the sedimentary surfaces, a transmissivity reduction coefficient; and
upscaling the fine-scale three dimensional model to obtain a coarse-scale three dimensional model comprising a plurality of cells, wherein each cell is associated to petrophysical parameters determined from the petrophysical parameters of the fine-scale model, and from the transmissivity reduction coefficient of the sedimentary surfaces.

2. A method according to claim 1, wherein the sedimentary surfaces are meshed with triangles, and the forming the unstructured grid comprises forming a plurality of tetraedric cells between two successive sedimentary surfaces, such that one face of a tetraedric cell corresponds to a triangular mesh of a sedimentary surface, and the summit of the tetraedric cell belongs to an adjacent sedimentary surface.

3. A method according to claim 1, wherein the transmissivity reduction coefficient is comprised between 0 and 1.

4. A method according to claim 3, wherein a modeled sedimentary surface having a transmissivity reduction coefficient of 0 represents a thin shale layer.

5. A method according to claim 1, wherein the attributing petrophysical parameters to each cell of the grid of the fine-scale model comprises:
determining a number of lithology types within the fine-scaled model and defining each lithology type,
determining a distribution pattern of the lithology types within the grid, and
attributing to each cell petrophysical parameters according to the determined distribution pattern.

6. A method according to claim 1, wherein the petrophysical parameters comprise at least porosity and permeability values.

7. A method according to claim 6, wherein the upscaling is performed by providing a coarse-scale grid comprising a plurality of cells, each cell having dimensions greater than a plurality of cells of the fine-scale model, and the upscaling of the permeability values is performed by computing equivalent fluid flow values of the cells of the coarse-scale grid from fluid flow values of the cells of the fine-scale grid and inferring equivalent permeability values of the coarse-scale grid.

8. A method according to claim 7, wherein the computation of the equivalent permeability values is performed by:
numerically solving—Darcy's equation to obtain, in each cell of the fine-scale model, a fluid head in the cell, said fluid head being determined from fluid head values at the limits of the fine-scale model, inferring a fluid flow value in each cell of the fine-scale model,
computing, from the fluid flow values in each cell and the transmissivity reduction coefficients, an equivalent fluid flow value in a cell of the coarse-scale grid comprising the cells of the fine-scale grid, and
inferring an equivalent permeability value of the cell of the coarse-scale grid from the equivalent fluid flow value.

9. A method according to claim 1, wherein the modelling of sedimentary surfaces comprises:
selecting a bedform type to be modelled among a library of previously established bedform types, wherein each bedform type defines a disposition of a plurality of sedimentary surfaces, and
parameterizing the selected bedform type.

10. A method according to claim 9, wherein the parameterizing of the bedform type is performed according to at least one of the following parameters:
wavelength of a cyclic geometric pattern of the sedimentary surfaces included in the bedform type,
steepness of said cyclic geometric pattern,
angular orientation of said cyclic geometric pattern,
number of sedimentary surfaces, and
mean thickness between two adjacent sedimentary surfaces.

11. A computer program product comprising code instructions for performing the method according to claim 1, when executed by a computer.

12. A non-transitory computer readable storage medium, having stored thereon a computer program comprising program instructions, the computer program being loadable into a computer and adapted to cause the computer to carry out the steps of the method according to claim 1, when the computer program is run by the computer.
